(19) United States
(12) Patent Application Publication
(10) Pub. No.: US 2007/0235901 A1
(43) Pub. Date: Oct. 11, 2007

(54) Apparatus and method for molding polymer parts by displacement-injection molding

(76) Inventor: Razmik Akopyan, Olathe, KS (US)

Correspondence Address: ERICKSON & KLEYPAS, L.L.C., 800 W. 47TH STREET, SUITE 401, KANSAS CITY, MO, 64112, US

(21) Appl. No.: 11/391,999

(22) Filed: Mar. 29, 2006

(51) Int. Cl. B29C 45/00

(52) U.S. Cl. 264/328.1; 425/544

(57) ABSTRACT

A displacement-injection molding system utilizes heating transfer elements extending into the cavity of a plasticizing vessel to decrease the time required to heat polymer granules to their injection temperature and a variable volume mold utilizing back pressure to maintain molten polymer injected into the mold under pressure to prevent the formation of voids or pores in the molded product. The heat transfer elements include cylindrical cores having electric heaters mounted therein. The ejection mechanism for ejecting molten polymer from the plasticizing vessel comprises a plunger having openings for receiving the cylindrical cores and passing thereacross.

### BACKGROUND OF THE INVENTION

This invention relates to systems and processes for molding relatively thick walled articles form fiber reinforced thermo-plastics which perform at extremely high temperatures and stresses. The processes and apparatus disclosed herein may also be utilized for molding of thermoset resins.

In my previously filed patent applications, including application Ser. No. 10/868,574 entitled Microwave Molding of Polymers, Publication No. US-2004-0222554-A1, and application Ser. No. 10/435,315 entitled Microwave Molding of Polymers, Publication No. US-2003-0224028-A1 and my issued U.S. Pat. No. 6,984,352, I disclose methods for creating compression molds for use in the compression molding of polymers using microwave energy to heat the polymer material to its melting point. The molds and processes disclosed therein are particularly well adapted for molding plastic polymers and composites having a relatively high operating temperature, including such high performance polymers as those sold under the trademarks PEEK®, TORLON®, SEMITRON®, DURATRON®, CELAZOLE®. The use of microwave energy to heat the polymer in the compression molds disclosed therein will result in significant energy savings compared to molding processes using electric or gas heating to heat the polymer material to its melting point.

In my previously filed patent application Ser. No. 11/108,523 entitled Injection Molding of Polymers By Microwave Heating, Publication No. US-2005-0184434, I disclosed methods and apparatus for injection molding of polymers utilizing microwave energy. This process is intended for molding thick walled parts from polymer in the form of pellets or powders, which provides a higher quality molded product compared to parts molded by compression molding. The mechanical properties of injection molded parts are usually higher then those of compression molded parts.

Using the molds formed in the manner disclosed in my prior applications, rapid and uniform heating of thermoplastic and thermoset materials by microwave energy may be achieved due to the volumetric nature of microwave (MW) heating. Polymer material in powder or pellet form is compacted within a mold cavity of the mold assembly which is placed into the resonance cavity of a multimode microwave oven and exposed to microwave radiation. Microwave energy uniformly heats the work material to the desired temperature at which the polymer material melts or softens. If this mold or plasticizing vessel is used for compression molding, the mold halves then may be squeezed together by a hydraulic press to mold or form the molten polymer into the desired shape. If this mold is used as a plasticizing vessel for injection molding, the uniformly heated polymer material is ejected from this plasticizing vessel into a conventional metal mold for shaping the material into the desired shape. In both cases, the microwave mold or plasticizing vessel is designed to provide relatively uniform heating of the polymer material or work material due to approximately equal heating rates of all of the mold members and the polymer resulting in relatively uniform heating of the polymer.

It is believed that the compression and injection molding techniques using microwave energy described in my prior published patent applications provide higher quality finished products, shorter processing times by a factor of approximately 10 or more, and reduced consumption of energy by the same factor. Nevertheless, in spite of significant advantages, microwave molding techniques are complex and require additional capital investment. In addition, the cooling time required for cooling thick walled parts to the mold opening temperature is generally significantly greater than the heating time by microwave molding. It therefore may be more practical to find an efficient design for the plasticizing vessel utilizing conventional electric heaters.

The idea of a variable volume mold cavity is known in the prior art. For example, in an injection-compression molding (ICM) process, two mold halves are maintained in a slightly open alignment as molten plastic is injected into the mold. Once the required amount of plastic to form the molded part is injected into the mold, the mold halves are advanced toward each other to close the mold and to provide improved flow of the melt into the all portions of the mold cavity to get a dense molded part without air voids. In contrast to injection-compression molding, Nomura et al. in U.S. Pat. Nos. 6,010,656 and 6,457,917 discloses a process for injecting molten resin into a variable cavity mold under pressure while the mold cavity is maintained at a first volume and then at the end of the injection cycle, expanding the volume of the mold cavity to rapidly decrease the pressure acting on the molten plastic, causing the molten plastic or resin to expand due to its internal gas pressure to obtain a relatively light product, low density product. A mat of glass fibers is preferably positioned in the mold to obtain a very light fiber-reinforced product of low density.

In both cases, the variation of the mold cavity begins either after completion of the injection or when it almost completed. In either cases, there exists a period of time when the melt is not fully compressed and it may expand, forming pores or voids in its volume. The formation of such air voids or porosity may be caused either by air trapped in the melt or due to hot gases of the melt. In ICM such air voids or porosity is removed from the melt by significant mold closing pressure and due to relatively small thickness of molded product and improved thickness to flow length relation. Neither of the described techniques are suitable for use in the injection molding of parts having relatively large cross-sections or thick walls. In thick walled parts, any air voids or pores formed in the injected plastic are likely to be trapped therein. As a result the molded part will be rejected.

There remains a need for systems for providing for the relatively rapid and uniform heating of high performance engineered plastics having relatively high operating temperatures using conventional heating sources such as electric heaters. There further remains a need for such systems for supplying molten plastic for injection molding applications in which the molded parts are of high quality and relatively free from air voids and pores.

### SUMMARY OF THE INVENTION

Disclosed herein is an alternative to the microwave molding techniques disclosed previously, which allows rapid and relatively uniform heating of polymer material by conventional electric heaters and the molding of parts from the polymer material without air voids or pores by a process which may be referred to as displacement-injection molding which is particularly well adapted for molding parts of relatively large cross sections and volumes. In molds I have described previously, the plasticizing vessel and the work material are heated by microwave energy and then the molten plastic is injected into the mold cavity. The plasticizing vessel described in the detailed description of the present invention includes a plurality of interior core heaters or heating elements to deliver heat into a central or interior region of the compacted pellets or powder. The core heaters are particularly well adapted for receiving conventional cartridge heaters or the like to provide the required heat. Such core heaters cannot be used in compression molding techniques because the core heaters would create holes in the molded part.

The molten plastic from the plasticizing vessel is injected into a variable volume mold having a movable bottom wall or plunger slidably mounted within and defining the distal end of the mold cavity. The mold plunger is advanced rearward or outward, against back pressure, upon injection of molten plastic into the mold cavity to expand the cavity in direct proportion to the amount of plastic injected therein. The initial volume of the variable mold cavity is approximately equal to zero which means that mold is almost fully closed. The position of the movable plunger corresponds to the amount of the melt Mᵢₙₛₜₐₙₜ, injected into mold cavity. The relation between the position of the plunger Xᵢₙₛₜₐₙₜ and the amount of injected material Mᵢₙₛₜₐₙₜ at any moment of time is given by the formula:
M_{ins tan t}=ρ·S·x_{ins tan t} (1)
Where:
S—is cross-sectional area of the mold cavity, inch²
ρ—is the density of fully compacted material at the melt temperature; lb/inch³.

For solid round parts cross-sectional area S_{round} is determined by the diameter of part D and is equal to:

$${S}_{round} = \frac{π {D}^{2}}{4}$$

For thick wall tubes cross-sectional area S_{tube} is determined by outside diameter D and internal diameter d and is equal to:

$${S}_{tube} = \frac{π}{4} ( {D}^{2} - {d}^{2} )$$

Formula (1) explains the relationship of the position of the plunger to the amount of plastic injected for the preferred embodiment of the present invention. At any moment of time during injection, the amount of injected melt Mᵢₙₛₜₐₙₜ should be equal to the quantity given by the formula (1). If at the current position of the plunger Xᵢₙₛₜₐₙₜ, the amount of injected material is less then that given by formula (1) it will cause the expansion of the melt due to internal gas pressure in the melt and formation of voids and/or porosity in the melt. On the other hand, the amount of injected material cannot exceed that given by (1) since when the melt is fully compacted its density cannot be further increased.

It is clear that maintaining the melt in the variable mold cavity at the fully compacted state during injection will require some back pressure applied to the movable plunger in the direction opposite to melt flow. This back pressure should withstand the internal gas pressure of the melt and should be applied to the movable plunger of the mold from the very beginning of the injection cycle up to its end when the plunger reaches the bottom of the mold. At this moment, the injection step is complete and the work piece is molded to its final dimensions. After completion of the injection step, back pressure should be maintained on the plunger until the mold cools down to the mold opening temperature. At the mold opening temperature, the molded part is completely solidified and back pressure may be released to allow opening of the mold and removing of the molded part.

The back pressure functions to eliminate air voids or porosity in the molding of thick walled parts. Back pressure is applied to the mold typically by a hydraulic cylinder, which retracts to expand the mold cavity against the pressure exerted by the molten plastic injected into the mold. The molten plastic is thereby injected into the mold cavity under pressure from two directions preventing the formation of voids or air pockets in the molded part. The disclosed method and apparatus allow efficient molding from pellets and powders of a wide variety of polymers. Virtually all polymers which are capable of flowing under pressure and heat may be molded by the disclosed displacement-injection molding apparatus and process disclosed herein.

The displacement-injection molding (DIM) system and process disclosed herein utilizes conventional heat transfer to melt or plasticize the plastic material including fiber reinforced plastics or plastics or polymers whose properties have been enhanced through the addition of various additives or the like. As used herein, the terms plastic and polymer are intended to include engineered materials in which reinforcing fibers or other additives have been added to enhance the properties of the material to be molded.

Amorphous and crystalline plastics behave differently during their heating. When amorphous plastic is heated to an injection or process temperature, it softens gradually from rigid to rubbery to a liquid state suitable for injection. For this reason amorphous plastics are characterized by a glass transition temperature, T_{g}. By contrast, when a crystalline plastic is heated, it remains solid until it reaches its melting point Tₘₑₗₜ. At that point it changes suddenly from a crystalline solid to a molten liquid and becomes amorphous. The process temperature is usually higher than the melting point of crystalline plastics, Tₘₑₗₜ, and higher than the glass transition temperature, T_{g}, of amorphous plastics. For simplicity, hereafter for all plastics the terms process or injection temperature shall refer to the temperature at which the plastic becomes semi-liquid with a viscosity suitable for injection. The recommended process temperature or injection temperature is typically given in the specification of each thermoplastic material provided by the supplier. As used herein, the word “melt” or “molten” refers to semi-liquid state of the plastic at the process or injection temperature.

The displacement-injection molding (“DIM”) system includes a plasticizing vessel for melting thermoplastic pellets or powder, a mold with a mold cavity for shaping injected plastic or work material, and a hydraulic unit which includes a press frame, a forward pressure or injection hydraulic cylinder, a back pressure hydraulic cylinder and one or more hydraulic pumps for feeding these cylinders. The plasticizing vessel, in which a selected quantity of granulated plastic work material is melted, consists of a side wall in the shape of hollow cylinder, a bottom wall with an attached nozzle and heating cores and a plunger for compression and ejection of the molten plastic or melt from the plasticizing vessel through the nozzle. The movable plunger contains through holes, which allow the plunger to slide along the cores during compression or ejection of the melt from the plasticizing vessel.

The injection hydraulic cylinder acts on the moveable plunger to provide forward pressure for compressing the plastic work material and for ejecting the molten work material from the plasticizing vessel into the displacement-injection mold cavity. The back pressure hydraulic cylinder acts on a movable floor or plunger in the mold to create back pressure on the injected melt which eliminates the formation of air voids and porosity in the resulting molded parts. The plasticizing vessel is adapted to permit compaction of the plastic work material prior to its heating in the vessel.

The plasticizing vessel is formed from a hollow metal cylinder surrounded by an external electrical band heater. The hollow metal cylinder surrounds or defines a plasticizing cavity which is closed off at a bottom end by a bottom end wall. A plurality of relatively small outlet openings or holes for dispersing and mixing of the melt may be formed in the bottom end member in communication with a nozzle connected to the bottom end wall. The plasticizing vessel plunger is advanceable through an inlet opening in a top end of the plasticizing vessel toward and away from the bottom end wall. At least one and preferably several core heaters are positioned within the plasticizing vessel preferably extending upward from the bottom end wall to enhance the heat transfer to the internal regions of compacted pellets and to provide enhanced uniformity of heating due to the high thermal conductivity of the metal core heaters. Although the core heaters preferable contain cartridge heaters inserted into the center of the cores, they may be heated by heat conduction alone from the hot walls of the plasticizing vessel through the bottom end wall and the plunger.

Tight tolerances should be provided between the plunger, side wall and cores to prevent flashing of the melt. All metal members of the plasticizing vessel are preferably made from hardened metal or alloys capable of withstanding high temperatures and high pressures. The nozzle may be permanently or removably attached to the bottom wall of the vessel. The plasticizing vessel preferrably includes structure, such as a multi-hole dispenser in the nozzle for dispersing and static mixing of the molten work material discharged therethrough.

Prior to placement in the plasticizing vessel, the plastic pellets or granules are preferably preheated by conventional heating means, such as by conduction or forced air heating. As used herein, the term granules is intended to include other solid, granular forms of the polymer material including pellets and powders. The granules are preferably preheated to or slightly above a heat deflection temperature, defined under 264 psi of stress, at which the plastic becomes pliable but does not yet become a liquid.

In a preferred embodiment, the pellets are preferrably compacted in the plasticizing vessel prior to heating therein to improve heat transfer through the pellets or granules. Preheating and compaction of the pellets provides significant improvement of the molding process for the following reasons: compaction of the pellets or powders in the plasticizing vessel allows more plastic material to be processed in the fixed volume of the vessel; and compaction of the pellets in the plasticizing vessel significantly increases the amount of surface area in contact between the pellets or fine powdered particles and reduces the amount of air trapped therebetween and, thus, significantly increases thermal conductivity of the compacted pellets, which improves heat flow through the compacted pellets resulting in a reduction of the time required for equalization of the temperature therethrough. The presence of core heaters allows for the delivery of heat directly to the central region of the compacted material and reduces the distance of heat flow. The heating time required to uniformly heat the compacted material to the desired temperature is significantly reduced.

With the plasticizing vessel positioned in the hydraulic unit, preheated plastic pellets or powder are poured by gravity into the plasticizing vessel through its inlet opening. The plasticizing vessel is also preheated prior to introduction of the plastic pellets and it retains much of its heat between ejection and filling cycles. The ejection actuator is utilized to compact the work material in the plasticizing unit. The movable plunger is removably coupled to the end of the ejection actuator piston which advances the plunger through the inlet opening of the plasticizing vessel, along the core heaters and toward the bottom end wall, compacting the pellets therebetween. To increase the shot capacity, the plunger may then be removed and an additional amount of preheated pellets may then be added into the heating vessel and compacted with the previously compacted pellets.

During the heating cycle the plunger may be heated by a built-in electrical cartridge heater or by a removable electrical disk heater with holes for the core heaters. In the latter case, the disk heater should be removable positioned between the plunger and the piston of hydraulic actuator and thermally insulated from the piston by a rigid insulator, such as a thick mica disk. The ejection actuator piston remains in an extended position under the pressure during the heating cycle to maintain the pellets in a compacted state during the heating cycle. The top plunger may not contain an electric heater and it may be heated by heat conduction from hot the sidewall of the vessel.

When compaction of the pellets is completed, the electrical heaters of the plasticizing vessel and mold members are actuated to raise the temperature of the pellets uniformly to the desired injection temperature. The temperature rise of each mold member may be controlled by electronic temperature controllers such as programmable logic controllers (PLC's). The granules or powder are heated by thermal conduction from the heated plasticizing vessel members including the core heaters.

Once the plastic granules are heated to the injection temperature for the selected plastic, the back pressure hydraulic cylinder is actuated to extend its piston and drive the movable plunger of the displacement-injection mold toward the injection port closing the mold. A valve between the plasticizing vessel and the mold cavity is opened and the molten plastic is ejected out of the plasticizing vessel through the nozzle and then through a sprue into the mold cavity of the mold which has been preheated to a temperature closely approximating the injection temperature.

In ejecting plastic from the plasticizing vessel into the mold, the forward pressure must be higher then the back pressure created by the back pressure cylinder to allow the melt to flow into the mold cavity. The injection rate for displacement injection molding is relatively slow in comparison with that of conventional injection systems due to the back pressure imparted by the back pressure hydraulic actuator. The difference in pressure between the ejection actuator and the back pressure actuator must be sufficient to overcome the melt's resistance to the flow due to its viscosity. The difference in pressure between the ejection actuator and back pressure actuator displaces the melt from plasticizing vessel to the mold.

When the displacement-injection mold is in the fully closed position the mold cavity is minimized and generally devoid of any air that might otherwise form bubbles or voids in the molded product. Under the pressure exerted by the ejection actuator, the molten plastic or melt, pushes against the bottom or displaceable wall in the mold cavity causing the back pressure cylinder to retract. When the bottom wall reaches the bottom of the mold, the mold cavity reaches its maximum volume. The valve between the plasticizing vessel and the mold cavity is closed and the forward hydraulic actuator piston and attached plunger are retracted out of the plasticizing vessel to open the inlet opening to the plasticizing vessel to permit filling of the plasticizing vessel with another load of preheated plastic granules for the next shot. The molten plastic in the mold is then cooled to mold opening temperature until the molded part solidifies. It is preferable to maintain the back pressure on the melt during cooling cycle to prevent the delaminating and/or formation of the cracks in the molded part while it shrinks. After completion of cooling cycle, the back pressure may be released, the mold may be opened and the molded part removed.

Generally, the cooling time exceeds the heating time of the work material in the plasticizing vessel. For this reason, it is practical to have one or more separate cooling stations, where the mold with the molded part may be transported for cooling down the part to mold opening temperature. During cooling the mold in the cooling station, the injection station may be prepared for next shot with another mold. Such cooling station should contain hydraulic cylinder for maintaining molded part under the pressure while it is cooling. The desired cooling rate may be provided by programmable logical controller (PLC).

The developed technique may be referred to as displacement-injection molding and allows to eliminate the formation of air voids or porosity in thick wall molded parts.

### BRIEF DESCRIPTION OF THE DRAWINGS

FIG. 1 is a partially exploded perspective view of a molding station of a displacement-injection molding system of the present invention with portions removed to show detail therein.

FIG. 2 is a perspective view of a cooling station of the displacement-injection molding system of the present invention with portions removed to show detail therein.

FIG. 3 is an enlarged and fragmentary view of a displacement-injection mold of the present invention.

FIG. 4 is an enlarged and fragmentary view of a plasticizing vessel of the present invention.

FIG. 5 is a fragmentary and diagrammatic cross-sectional view of an alternative embodiment of the plasticizing vessel of the present invention.

FIG. 6 is a diagrammatic, cross-sectional view taken generally along lines 6-6 of FIG. 5.

FIG. 7 is a perspective view similar to FIG. 1 showing a piston of an ejection actuator in an extended position advancing a plunger of the plasticizing vessel toward an outlet end wall of the plasticizing vessel for ejecting polymer work material from the plasticizing vessel.

FIG. 8 is a schematic view of a conventional oven for use in preheating and drying plastic granules for further heating in and ejection from the plasticizing vessel of the displacement-injection molding system.

FIG. 9 is a schematic view of successive steps of the displacement-injection molding process of the present invention.

FIGS. 10a-c are diagrammatic views showing displacement of molten plastic from the plasticizing vessel to the displacement-injection mold and showing the forward and backward directed pressures acting on the molten plastic.

FIG. 11 is a diagram including a set of curves showing the temperature distribution inside the plasticizing vessel without a heat transfer core at different times during transient heat transfer.

FIG. 12 is a diagram including a set of curves showing the temperature distribution inside the plasticizing vessel with a heat transfer core at different times during transient heat transfer.

FIG. 13 is an exploded and fragmentary perspective view of an alternative embodiment of the displacement injection mold for molding hollow tubes and utilizing a core for forming the bore in the tube.

FIG. 14 is a perspective view of a hollow tube formed by the mold shown in FIG. 13.

FIG. 15 is a perspective view of a collapsible core for use in association with the mold shown in FIG. 13.

### DETAILED DESCRIPTION OF THE INVENTION

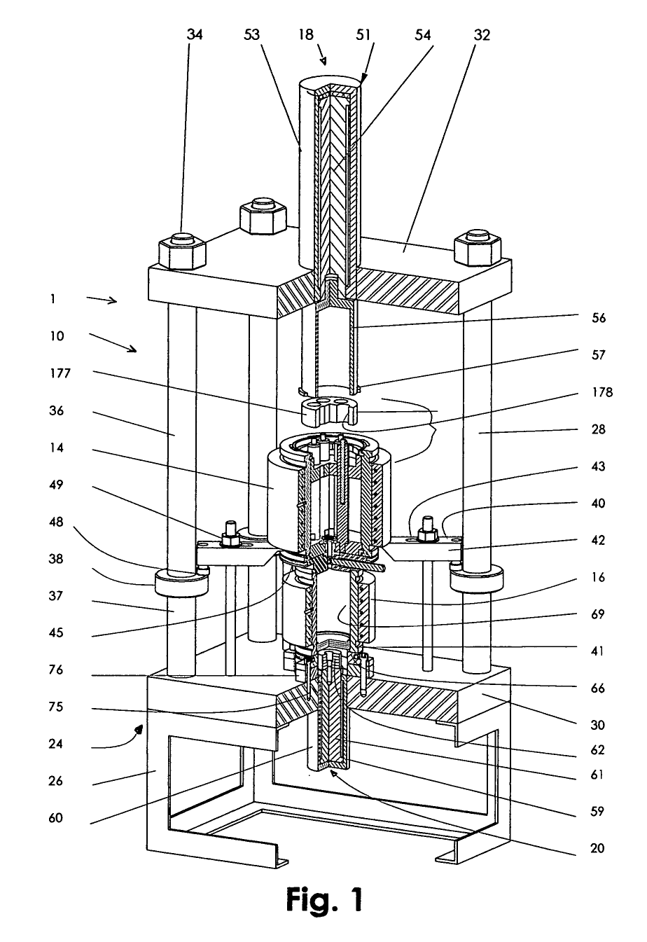

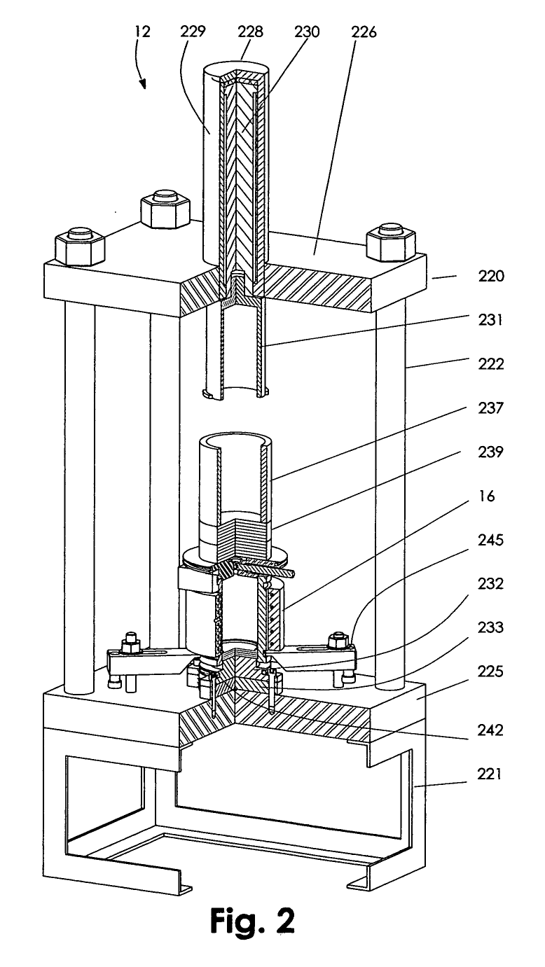

Referring to the drawings in more detail, a preferred embodiment of a displacement-injection molding system 1 is shown in FIGS. 1 and 2. The molding system consists of a molding station 10 (FIG. 1) and cooling station 12 (FIG. 2). The molding station 10 comprises a plasticizing vessel 14 in which plastic granules are received and heated to their melting point, a displacement-injection mold 16 where the molded part is shaped and solidified, an ejection or injection assembly 18 for ejecting molten plastic out of the plasticizing vessel 14 and into the mold 16 and a back pressure assembly 20 for creating pressure to resist the flow of molten plastic into the mold 16. The foregoing components of the injection station 10 are all mounted or adapted to be supported on a frame 24 which is shown resting on a pedestal or base 26.

Frame 24 comprises a set of tie bars or tie bar assemblies 28 which are fixedly connected to and extend upward from a base plate 30 to an upper plate 32. Each tie bar assembly 28 includes a threaded tie bar 34 extending through upper and lower hollow spacers or tubes 36 and 37 and an annular support member or ring 38. The support ring 38 is positioned above and supported on the lower spacer 37 and the length of the lower spacer 37 is selected space the support ring 38 at a desired height as discussed in more detail hereafter. The upper and lower spacers 36 and 37 in combination with the support ring 38 function to set the desired spacing between the base plate 30 and upper plate 32. The frame 24 is designed to withstand the pressures generated by the injection assembly 18 and back pressure assembly 20 acting on the plasticizing vessel 14 and the displacement-injection mold 16 respectively.

At least two clamps or clamping assemblies 40 may be employed for clamping or securing the plasticizing vessel 14 against the displacement-injection mold 16 and the displacement-injection mold 16 against the base plate 30. Each clamping assembly 40 includes a threaded extension bar 41 threadingly connected to and extending upward from the base plate 30 and a slotted clamp member 42. The extension bar 41 extends through a slot 43 in the clamp member 42 which allows vertical and horizontal adjustment of the position of the clamp member 42 relative to the extension bar 41. An inwardly projecting lip 45 on one end of the clamping member 42 is adapted for selective engaging the plasticizing vessel 14 to hold the plasticizing vessel 14 and the displacement-injection mold 16 in place as generally shown in FIG. 1 and as discussed in more detail hereafter.

An outer end of each clamping member 42 is supported on an associated supporting ring 38 of the frame assembly 24 by an adjustable bolt or height adjustment mechanism 48 threadingly secured to a rear end of each clamping member 42. The adjustable bolt 48 is threadingly connected to the clamping member 42 to permit raising and lowering of the outer end of the clamping member 42 to correspond to the height of the lip 45. A nut 49 on the end of each extension bar 41 can be tightened downward on the threaded end of the extension bar 41 to draw the clamping member 42 down tight against the plasticizing vessel 14 and the supporting ring 18.

Referring to FIG. 1, the injection assembly 18 comprises a first linear actuator 51 including a cylinder 53 which is secured to upper plate 32 and a piston 54 reciprocally mounted within the cylinder 53 and extending through an opening in the upper plate 32. The injection assembly 18 may also be referred to as a forward pressure assembly for providing pressure in a first or forward direction. A piston head 56 is threadingly connected to the outer end of the piston 54. The piston head 56 includes a plurality of lugs 57 for use in coupling with a moveable end wall or plunger of the plasticizing vessel 14 as discussed hereafter. The back pressure assembly 20 comprises a second linear or hydraulic actuator 59 including a cylinder 60 which is secured to the base plate 30 and a piston 61 reciprocally mounted within the cylinder 60. An insulating member or pad 62 is connected to and forms a distal end of the piston 61 for insulating the hydraulic actuator 59. Although, forward and back pressures may be created by air cylinders or other means, it is practical to use hydraulic cylinders when the required capacity of such actuators exceeds 25 tons.

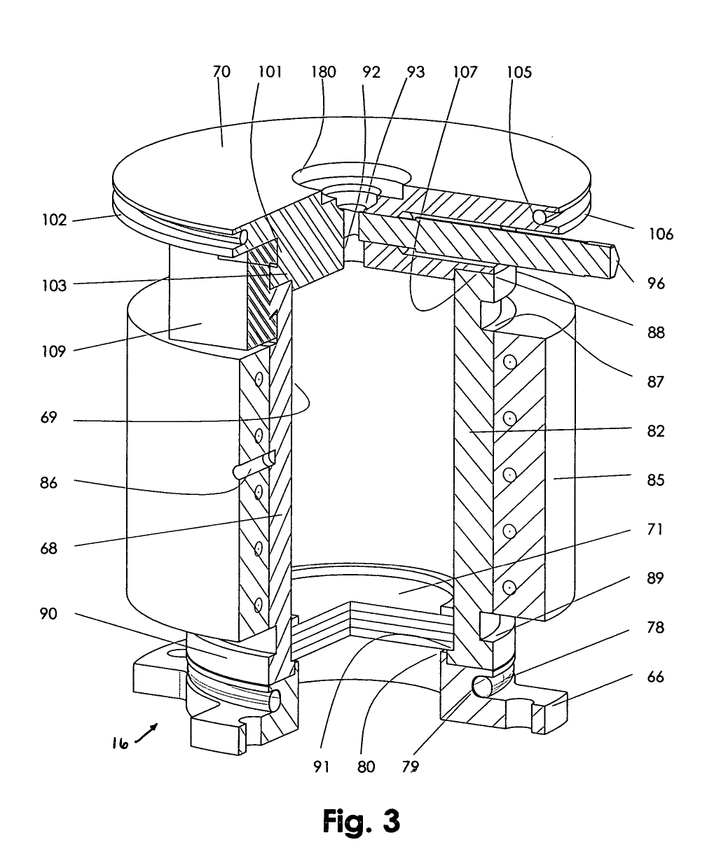

The mold 16, is best shown in FIG. 3 in which portions have been removed to show interior detail thereof. For illustrative purposes, the mold 16 is shaped for molding cylindrical parts exceeding several inches in diameter. It is to be understood that the mold may be designed or shaped to mold parts of various shapes and dimensions.

The mold includes a base mounting flange 66, a mold sidewall 68 defining a variable volume mold cavity 69, an inlet end wall or upper flange member 70 and a moveable mold member, wall or plunger 71 slidably mounted within the mold cavity 69 to vary the volume of the mold cavity 69. As shown in FIG. 1, the base mounting flange 66, which is preferably formed from metal, is connected to the base plate 30 by bolts 75 with a layer of insulation 76 interposed therebetween to thermally separate the mold 16 from base plate 30. Insulation of the mold 16 from the base plate 30 permits increased efficiency in preheating and cooling of the mold 16 during molding cycles. Silicon bonded mica plates or glass-mica plates may be used as a material for insulating layer 76. Silicon bonded mica can withstand temperatures up to 1292° F., compression pressure of up to 17,000 psi and has very low thermal conductivity.

The base mounting flange 66 and the insulating layer 76 are annular, having central openings extending therethrough in alignment with a hole in the base plate 30 through which the back pressure assembly piston 61 extends for engagement with the moveable mold member or wall 71. Referring again to FIG. 3, a bendable, tubular cartridge heater 78 is positioned or mounted in a circumferential groove 79 formed in the outer periphery of the base mounting flange 66 for preheating the flange 66 as well as portions of the mold sidewall 68 by conduction during the heating cycle. The heater 78 may also be used to control the uniformity and rate of cooling of the mold components during a cooling cycle. The base mounting flange 66 may include an upwardly projecting lip 80 extending around the central opening in the mounting flange 66 for use in centering the mold sidewall 68 thereon as discussed hereafter.

In the embodiment shown in FIG. 3, the mold sidewall 68 is generally formed as a hollow metal cylinder or sleeve 82, with an internal bore or chamber, and is surrounded by a band heater 85 such as can be purchased from Plastic Process Equipment Incorporated which generally comprises a heating coil surrounded by a layer of ceramic material with an outer insulating layer all housed in a metal enclosure A thermocouple (not shown) may be connected to the mold sidewall 68 through a hole 86 in the band heater 85 to control the temperature by electronic means (not shown). The lower end of the mold sidewall 68 is supported or mounted on an upper surface of the base mounting flange 66 and over the mounting flange lip 80 for centering the sidewall in alignment with the hydraulic actuators 51 and 59.

A first circumferential groove 87 is formed in the outer surface of the sleeve 82 near its upper or inlet end to form a first outwardly projecting flange or upper flange 88 extending thereabove. A second circumferential groove 89 is formed in the outer surface of the sleeve 82 near its lower or distal end to form a second outwardly projecting flange or lower flange 90 extending thereabove. An inwardly projecting lip or shoulder 91 is formed on or removably mounted on an inner surface of the sleeve near its lower or distal end to create a stop to prevent the moveable mold member 71 from sliding past the shoulder 91.

The inlet end wall 70 shown is formed from metal and includes a sprue 92 extending therethrough which opens into a hemi-spherical depression 93 formed in the outer surface of the inlet end wall 70 for receiving a nozzle 94 of the plasticizing vessel 14. The sprue 92 comprises a passageway in communication with the mold cavity 69 through which molten plastic from the plasticizing vessel 14 may be injected into the mold cavity 69. A valve 96 is mounted within the inlet end wall 70 of the mold 16 and selectively operable for closing the sprue 92 to control the flow of molten plastic into the mold cavity.

A first circumferential groove 101 is formed in an outer surface of the inlet end wall 70 and generally separates an upper radial flange 102 from a lower radial flange 103. In the embodiment shown, the upper radial flange 102 is larger in diameter than the lower radial flange 103. A bendable cylindrical cartridge heater 105 is positioned within a circumferential groove 106 formed in an outer surface of the upper radial flange 102 of the inlet end wall 70 for heating or otherwise controlling the temperature of the inlet end wall 70 during heating and cooling stages.

The inlet end wall 70 is supported on and generally closes off the upper end of the metal sleeve 82 of the mold sidewall 68. An annular recess 107 may be formed in a bottom surface of the inlet end wall 70 to receive the upper end of the sleeve 82 and ensure proper alignment of the inlet end wall 70 with the sleeve 82. Clamping blocks or dove tail clamps 109 (one of which is shown in FIG. 3) may be slid into engagement with the upper flange 88 on the sleeve 82 and the lower flange 103 on the inlet end wall 70 to secure the inlet end wall 70 to the sleeve 82. The flanges 88 and 103 may include undercuts to form a dovetail shape to ensure the inlet end wall 70 remains connected to the sleeve 82 during the molding process and during transportation of the mold 16 to the cooling station 12.

The moveable mold member 71, which may also be referred to as a mold plunger, is driven by the piston 61 of back pressure hydraulic actuator 59. The piston 61 is thermally insulated from moveable mold member 71 by the insulating pad or layer 62 mounted on the end of the piston 61 to protect the actuator 59 from overheating. A silicon bonded mica disk of 1-2 inches thickness may be used for such thermal insulation. During the heating cycle the piston 61 of the back pressure actuator 59 is fully retracted allowing engagement or abutment of the moveable mold member 71 with the inwardly projecting lip or shoulder 91 secured on the inner surface of the mold sidewall 68 near its lower edge to prevent the moveable mold member 71 from sliding past the shoulder 91 and the bottom edge of the mold sidewall 68. With the moveable mold member 71 positioned against the shoulder 91, the mold 16 may be described as being in its fully opened state, maximizing the volume of the mold cavity 69.

When the back pressure actuator 59 is fully extended, the moveable mold member preferably extends in closely spaced relation to the inlet end wall 70 to minimize the volume of the mold cavity. It is preferable to leave a slight gap between the moveable mold member 71 and the inner surface of the inlet end wall 70 to provide sufficient surface area across the moveable mold member 71 upon which the molten plastic may act to overcome the back pressure exerted by the back pressure actuator 59. The gap may be formed by restricting upward movement of the hydraulic piston 61. It may also be formed by a variety of means including an inwardly projecting lip on the inner surface of the inlet end wall 70 or an upwardly projecting circumferential lip on the moveable mold member 71.

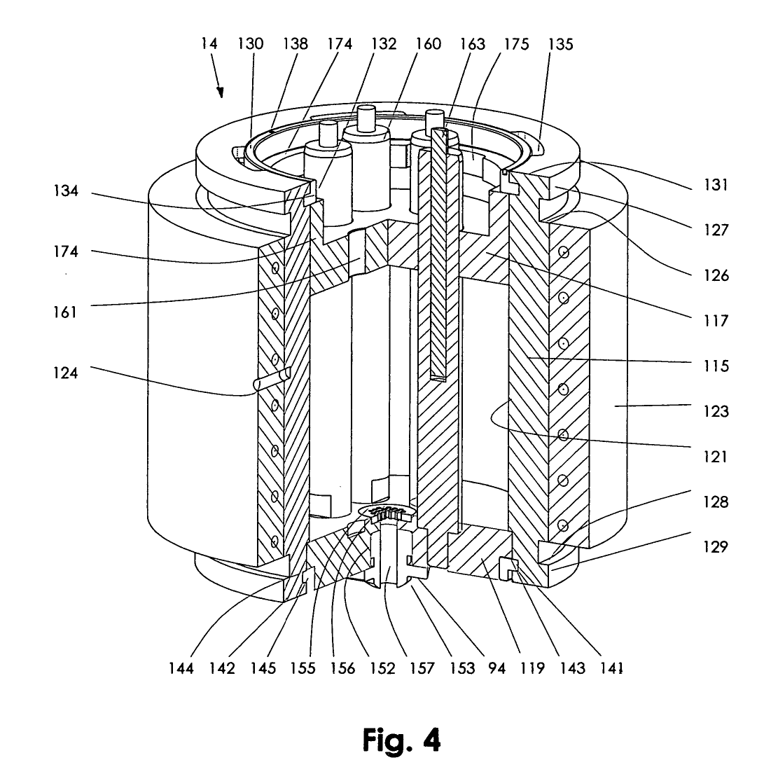

Plasticizing Vessel: The plasticizing vessel 14, as best seen in FIG. 4, is adapted to receive pellets of a plastic or polymer work material and uniformly heat the pellets to an injection temperature. The injection temperature is the temperature at which the polymer work material has a viscosity suitable for injection (or displacement) into the mold or in other words a temperature at which the plastic may be injected into the displacement-injection mold 16. In the embodiment shown in FIG. 1, the plasticizing vessel 14 is supported on top of and in flow communication with the displacement-injection mold 16 and is acted upon by the ejection or injection assembly to force the molten contents of the plasticizing vessel 14 into the displacement-injection mold 16.

Referring again to FIG. 4, the plasticizing vessel 14 comprises a cylindrical wall or metal sleeve 115, moveable end wall or plunger 117 and a stationary end wall 119 defining a plasticizing vessel cavity 121 in which the plastic granules are received, compacted and heated to their injection temperature. The sleeve 115 preferably is made of a hardened metal or alloy to withstand high pressures and temperatures. High-speed tool steel may be employed as the material for the plasticizing vessel and the displacement-injection mold members. The sleeve 115 is surrounded on its outer surface by an electrical band heater 123 generally of the same type used for the mold 16 such as ceramic band heaters sold by Plastic Process Equipment, Inc. These band heaters have built-in ceramic thermal insulation which significantly reduces heat radiation. The band heater 123 also contains a small hole 124 for the attachment of the thermocouple to the sleeve 115 to control its temperature during heating cycles. The metal sleeve 115 and the band heater 123 may be collectively referred to as the plasticizing vessel sidewall or circumferential sidewall 125.

A first or upper circumferential clamping channel 126 is formed in an outer surface of the metal sleeve 115 near an upper end thereof. The channel 126 forming an upper flange 127. A second or lower circumferential clamping channel 128 is formed in an outer surface of the metal sleeve 115 near a lower end thereof. The channel 128 forming a lower flange 129. The lower channel 128 is adapted to receive the clamping member 42 for securing the plasticizing vessel 14 in place on the mold frame 24. The upper channel 126 is used for engagement of a pulling device (not shown) to raise or remove the plasticizing vessel 14.

With reference to the plasticizing vessel 14 as oriented in FIG. 4, the stationary end wall 119 is positioned below the plunger or moveable end wall 117. The end walls 117 and 119 are preferably formed of hardened metal or alloy and provide tight tolerances to prevent molten plastic from leaking between the end walls 117 and 119 and the sleeve 115, but do permit the plunger 117 to slide relative to the sleeve 115.

A top lock ring 130 is removably securable to the metal sleeve 115, near a top or upper end 131 thereof to form an inwardly directed shoulder or lip 132 which prevents the plunger 117 from sliding past or out of the upper end 131 of the sleeve 115. The top lock ring 130 may incorporate lugs 134 for making a bayonet type connection to the sleeve 115 to facilitate quick and easy securement and removal of the lock ring 130 with the sleeve 115. However, the lock ring 130 may be removably secured to the metal sleeve 1 by other means, such as for example, by mating threads on the outer surface of lock ring 130 and the inner surface of the upper end 131 of metal sleeve 115. In FIG. 4 the lock ring incorporates four lugs which cooperate with four slots 135 formed in the sleeve 115 to make the bayonet connection.

The lock ring 130 is connected to the sleeve 115, by insertion of the lugs 134 in the slots 135 and then rotating the lock ring 115 45° in either direction. One or more tool receiving holes 138 are preferably formed on an upper or outer surface of the upper lock ring 130 to receive a tool for use in separating the top lock ring 130 from the metal sleeve 115. When the plasticizing vessel 14 is in use, the top plunger 117 generally abuts and engages the top lock ring 130 proximate the upper end 131 of the sleeve 115. For refilling pellets prior to the next shot, the top plunger 117 may be removed from the sleeve 115 through the upper end 131 by first removing the lock ring 130. It is foreseen that the plasticizing vessel 14 could be utilized without the top lock ring 130.

A second or bottom lock ring 141 is removably securable to the metal sleeve 115 near a lower or bottom end 142 thereof to form an inwardly directed shoulder or lip 143. The bottom lock ring 141, may be identical in construction to top lock ring 130 including lugs 144 which cooperate with bayonet slots 145 formed in the sleeve 115 to permit a bayonet type connection of the bottom lock ring 141 to the sleeve 115. When secured to the lower end 142 of the metal sleeve 115, the bottom lock ring 141 prevents the stationary or lower end wall 119 from sliding out of the sleeve 115 past the lower end 142. One or more tool receiving openings or holes 146 are formed in the outer end or surface of the bottom lock ring 141 to receive a tool for use in separating the bottom lock ring 141 from the metal sleeve 115. The bottom end wall 119 may be removed from the sleeve 115 through the lower end 142 for maintenance and the like by first removing the bottom locking ring 141.

The nozzle 94, preferably made of a hardened metal or alloy, is mounted in a threaded, nozzle receiving hole 152 in the bottom end wall 119. The nozzle 94 is screwed into the bottom end wall 119 and has a semi-spherical curved distal end 153. The nozzle 94 may include an inlet plate 155 having a plurality of mixing holes 156 formed therein, in communication with a main interior passageway 157 through the nozzle 94. The mixing holes 156 provide static mixing and dispersing of the molten plastic as it is forced out of the plasticizing vessel 14 and through the passageway 157 of nozzle 94 and to the mold 16.

A plurality of heat transfer members, heating elements or cores 160, five in the embodiment shown in FIG. 4, are threadingly connected to the bottom end wall 119 and extend upward therefrom through holes 161 in the plunger moveable end wall or plunger 117 and generally to the top of the plasticizing vessel 14. The cores 160 generally extend in parallel alignment with an axis of the plasticizing vessel cavity 121. The core receiving holes 161 formed in the plunger 119 are sized to form a relatively snug fit around the cores 160 to prevent molten plastic from flowing therethrough but are large enough to permit the plunger 119 to slide across or over the cores 160. The cores 160 function to deliver heat directly to the central region of the plasticizing vessel cavity 121 to reduce the distance of heat flow during the heating cycle. The cores 160 are preferably formed from metal and heated by electric cartridge heaters 163 inserted in bores 164 formed in the upper end of the cores 160. The cartridge heaters 163 preferably contain built-in thermocouples for electronic control of their temperatures. It is foreseen that the cores or heat transfer members 160 could function to transfer heat without the connection of heating elements or cartridge heaters 163 directly thereto, but instead simply serve as a conduit for transferring heat generated by heaters mounted on interconnected portions of the plasticizing vessel.

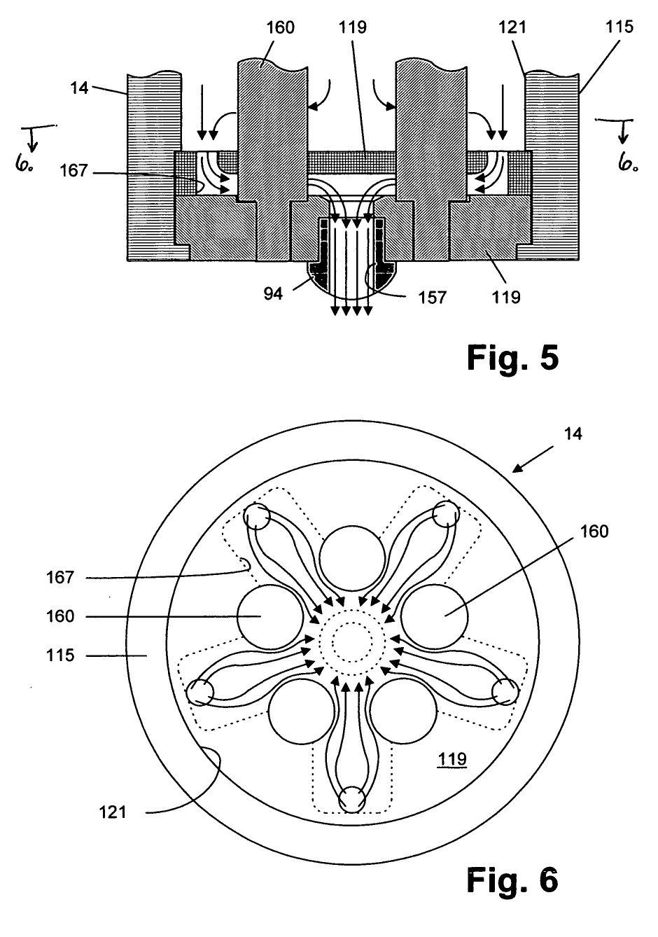

FIGS. 5 and 6 show an alternative embodiment of the stationary or bottom end wall 119 in which channels 167 are formed in the bottom end wall 119 to achieve static mixing of the plastic melt. The channels 167 open into the plasticizing vessel cavity 121 proximate the inner wall of the sleeve 115 and then flow into and communicate with the main passageway 157 of the nozzle 94.

Referring again to FIG. 4, the plunger 117 of plasticizing vessel 14 may include a heating element which may be secured to or mounted in the plunger 117 to heat the plunger 117. The plunger 117 includes an upwardly projecting circumferential rim 174 with bayonet slots 175 formed therein to permit relatively quick and easy connection or coupling of the piston head 56 of the ejection assembly 18 to the plunger 117.

The piston 54 of the first hydraulic actuator 51 is selectively advanceable between a retracted position wherein the piston head 56 is spaced above the upper surface of the plasticizing vessel plunger 117 (as shown in FIG. 1) and an intermediate extended position in which the piston head 56 abuts against the upper surface of the plasticizing vessel plunger 117, with a layer of rigid insulation 177 positioned between the upper surface of the plasticizing vessel plunger 117 and the end of the piton head 56. The layer of rigid insulation 177 includes holes 178 for receiving and sliding past the cores 160. The layer of insulation 177 prevents overheating of the injection assembly actuator 51.

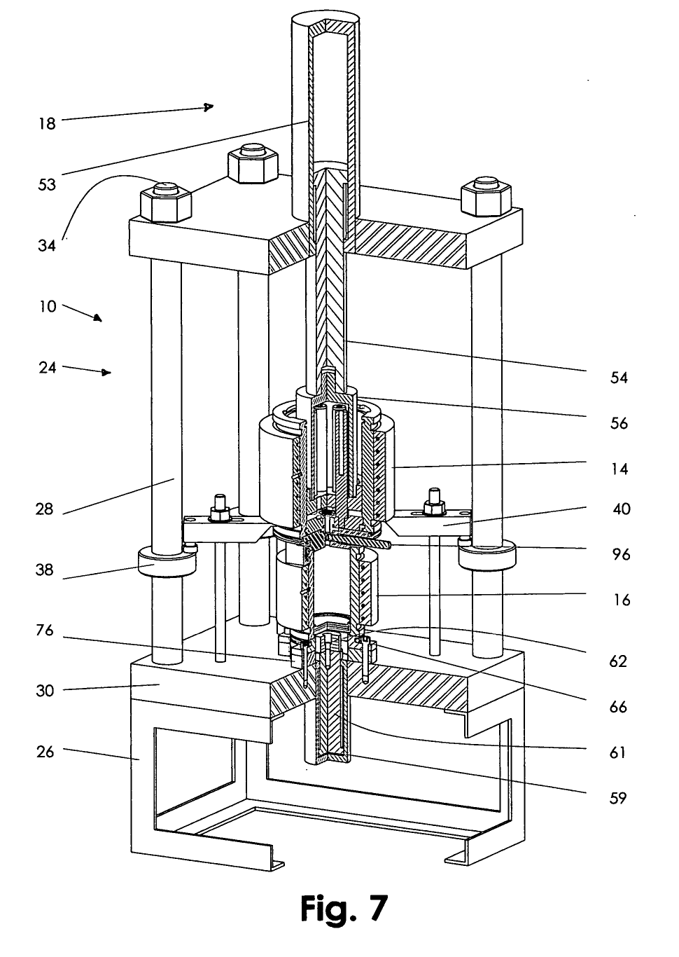

The piston 54 is further advanceable to a fully extended position wherein the plunger 117 is driven into engagement with the bottom end wall 119 of the plasticizing vessel 14. Referring to FIG. 7, the piston 54 is shown advanced to nearly a fully extended position. Connection of the piston head 56 to the plunger 117 permits retraction of the plunger 117 out past the end of the plasticizing vessel sleeve 115 upon retraction of the piston 54 from the fully extended position or the intermediate extended position, to the fully retracted position. It is noted that the top lock ring 130 must be removed from the metal sleeve 115 prior to removal of the plunger 117 therefrom upon retraction of the piston 54 to the retracted position.

When the plasticizing vessel 14 is placed on the inlet end wall 70 of the mold 16 as generally shown in FIG. 1, the outer surface of plasticizing vessel bottom end wall 142 abuts against the upper surface of the mold inlet end wall 70. The nozzle 94 extends into the hemi-spherical depression 93 of the sprue 92 with a relatively small clearance therebetween. A relatively wider diameter locating hole 180 of inlet end wall 70 assists to the primary engagement of the nozzle 94 with inlet end wall 70. With the plasticizing vessel 14 properly positioned on the displacement-injection mold 16, the plasticizing vessel 14 and mold 16 may be secured in place on the frame 24 using the clamping assemblies 40. In particular, the clamp members 42 are positioned to engage the plasticizing vessel 14 such that the lip 45 of each clamp member 42 extends into the lower circumferential channel 128 in sleeve 115.

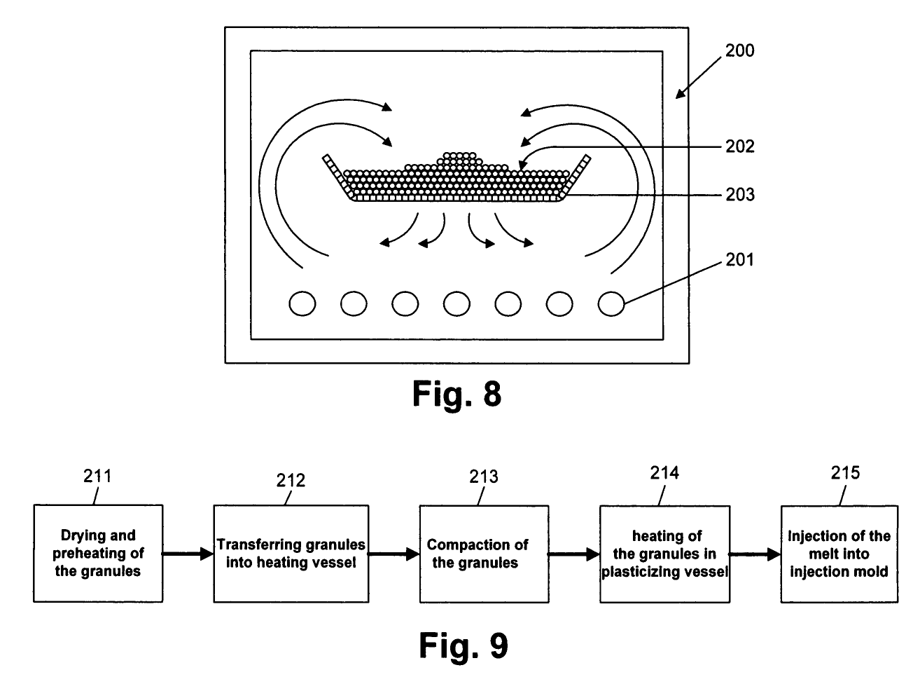

Molding Process: The pellets or granules of the work material used in the plasticizing vessel 14 are preferably preheated prior to placement in the plasticizing vessel. The pellets or granules may be preheated by conventional heating means, such as convection oven 200 utilizing gas burners or electrical heaters 201 with air circulation as shown diagrammatically in FIG. 8. The polymer granules or pellets 202 are shown on a tray or conveyor belt 203 and may be preheated by such conventional means to or above the heat deflection temperature, which corresponds to the temperature at which the plastic generally becomes pliable but not yet a liquid. The heat deflection temperature at 264 psi, T_{deflection}, a glass-transition temperature T_{g}, melting point temperatures Tₘₑₗₜ and process temperatures T_{process} of some crystalline and amorphous high performance thermoplastics for which the molding system of the present invention is particularly well adapted for processing are set forth in the following table:

| | | | Ketron | Semitron |
|---|---|---|---|---|
| | Ultem 1000 | Torlon 5530 | PEEK | ESd 420 |
| T_{deflection}, ° F. | 400 | 520 | 450 | 410 |
| T_{g}, ° F. | 419 | 527 | N/A | 428 |
| Tₘₑₗₜ, ° F. | N/A | N/A | 644 | N/A |
| T_{process}, ° F. | 600 | 650 | 750 | 610 |

After drying and preheating of the granules, pellets or powder in the conventional oven 200 with air circulation, as shown schematically in FIG. 9 at 211, the work material is transferred to the plasticizing vessel 14 at 212. Granules are poured by gravity or by means of a feed tube into the plasticizing vessel cavity 121. Although not shown, it is foreseen that the preheated granules may be transferred to the plasticizing vessel 14 by various automated transfer means, including belt or screw conveyors. To prevent the temperature of the granules from dropping below the heat deflection temperature upon placement in the plasticizing cavity 14, the plasticizing vessel 14 should be preheated to that temperature or above.

While the plasticizing vessel 14 is being preheated, the mold sidewall 68, mold inlet end wall 70 and the moveable mold wall 71 are preheated by their bendable cartridge or band heaters to a desired temperature, which provides for quality cavity filling without wrinkles or welding lines. The temperatures of these mold members 68, 70 and 71 are determined by trial for each particular plastic material and are generally close to the injection temperature of the melt.

After preheating of the plasticizing vessel 14 and the mold 16, the piston 54 with attached extension head 56 is extended to abut against the plasticizing vessel plunger 117 and with the lugs 57 on head 56 extending into the bayonet slots 175 in the upstanding rim 174 of plunger 117. The head 56 is then rotated 45° to connect the head 56 to the plunger 117 with a bayonet type connection. The top lock ring 130 is removed from the sleeve 115 and the piston 54 is retracted to withdraw the top plunger 117 from the plasticizing vessel 14. As discussed above, a first selected quantity of preheated plastic pellets, granules or powder is transferred from the preheating assembly and poured into the plasticizing vessel cavity 121.

At this stage of operation valve 96 in the inlet end wall 70 of mold 16 is usually in a closed position from the previous shot or it must be closed to prevent polymer pellets from dropping in to the opened mold 16. The piston 54, with the plunger 117 connected thereto is extended until it engages and compresses the polymer granules in the plasticizing vessel cavity 121 as shown schematically at 213 in FIG. 9. A second quantity of preheated work material may be added into plasticizing vessel cavity 121 and compacted as the first quantity to increase the shot capacity.

The top lock ring 130 may be connected to the sleeve 115 to prevent inadvertent removal of the plunger 117 from the sleeve 115. All of the heaters of plasticizing vessel 14 including the cores 160 are then activated to heat the compacted work material contained therein as shown schematically at 214 in FIG. 9. The temperature settings of each heater are set to be equal to the injection temperature of the work material and are controlled by a PLC or standard multi-zone electronic temperature controllers sold, for example, by D-M-E Corporation. The bottom lock ring 141 connected to the sleeve 115 prevents the bottom end wall 119 from being forced out of the sleeve 115 during compaction and injection stages.

Once the polymer work material is heated to its injection temperature, all of the heaters of plasticizing vessel 14 are turned off. The piston 61 of back pressure assembly 20 is actuated to drive the mold plunger 71 upward and into engagement with the mold inlet end wall 70. When the mold plunger 71 is advanced upward, air contained in the mold cavity 69 escapes or is vented through vent holes (not shown) located at the interfaces of the inlet end wall 70 and mold plunger 71 with the mold sidewall or sleeve 68. The back pressure exerted on the mold plunger 70 by the piston 61 is generally maintained constant during the injection and cooling stages.

The valve 96 in the mold inlet end wall 70 is opened by turning it 90° in either direction to align a through hole in the valve 96 with the passageway of the sprue 92. The actuator 51 of injection assembly 18 is actuated and piston 54 with attached piston head 56 and plasticizing vessel plunger 117 connected thereto are extended to drive the plunger 117 toward the stationary end wall 119 of the plasticizing vessel, forcing the molten work material out of the plasticizing vessel cavity 121, through the nozzle 94, through the sprue 92 and into the closed mold cavity 69 as represented schematically in at 215 in FIG. 9. Forward pressure on the plasticizing vessel plunger 117 exceeds the back pressure on the mold plunger 71 allowing the melt to flow in the direction to the mold cavity 69. As the molten work material is forced into the mold cavity 69 under pressure, the work material drives the mold plunger 71 rearward against the back pressure exerted thereon by the back pressure assembly 20 including by the second linear actuator 59. To prevent damage to the back pressure assembly 20, a relief valve (not shown) should be connected to the hydraulic fluid supply lines for the back pressure linear actuator 59.

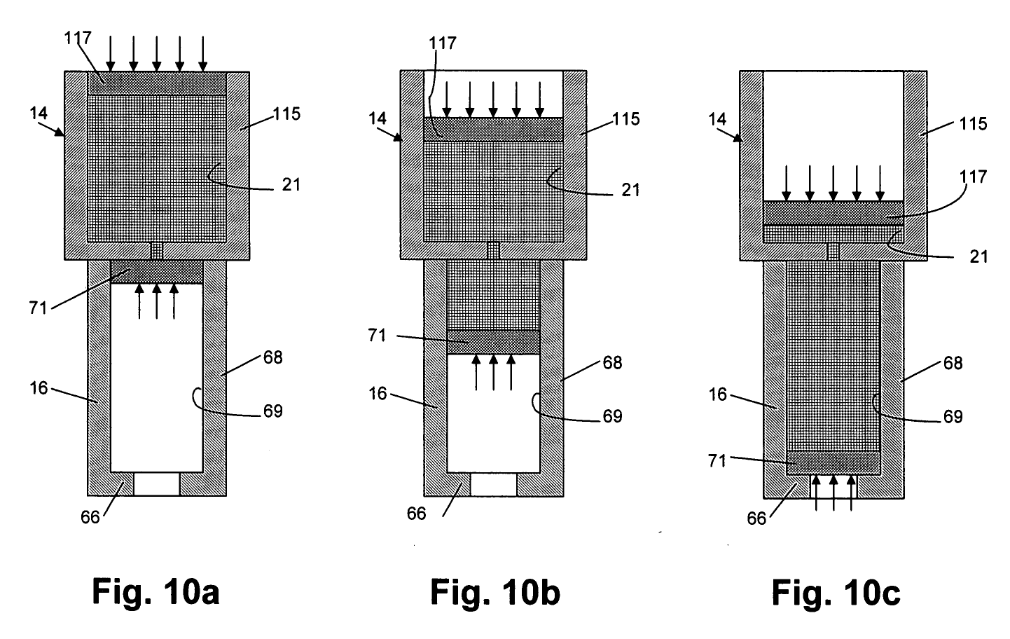

The back pressure should be high enough to prevent the formation of air voids and porosity due to hot gases in the work material injected into the mold cavity 69. The difference between the forward pressure exerted by the plasticizing vessel plunger 117 and the back pressure exerted by the mold plunger 71 should be greater than the pressure drop through the sprue 92 and the nozzle 94 due to the viscosity of the melt. Under these preferred conditions, the flow of the melt from plasticizing vessel cavity 121 to the mold cavity 69 may be characterized as displacement rather then injection. In a conventional injection molding process the melt is injected into the mold cavity only under the forwardly directed injection pressure. The process of displacement molding is schematically illustrated in FIG. 10a-c. FIG. 10a shows the relative positions of the movable plasticizing vessel or top plunger 117 and the mold or bottom plunger 71 at the beginning of the injection or displacement process. FIG. 10b shows intermediate positions of the top and bottom plungers 117 and 71 during displacement of the melt Final positions of the top and bottom plungers 117 and 71, after displacement or injection is completed are shown in FIG. 10c.

When the mold plunger 71 reaches its fully retracted position at the base mounting flange 66, the melt displacement is accomplished. Full displacement or filling of the mold may be determined by a sudden increase in forward pressure. At this moment the valve 96 is closed by turning it 90° in either direction to close the sprue 92.

To prepare the mold 16 for transportation to the cooling station 12, after closing the valve 96, the dove tail clamps 109 are installed to clamp the mold inlet end wall 70 to the mold sidewall 68. Piston 61 of back pressure assembly 20 is fully retracted, separating the piston 61 from the mold plunger 71 and releasing the back pressure. The clamping members 42 are repositioned to engage the mold 16, along either the upper or lower circumferential grooves 87 or 89 of the mold sidewall 68, and secure the mold to frame 24. With the piston head 56 of injection assembly piston 54 still connected to the plasticizing vessel 14, piston 54 is fully retracted, raising and separating the plasticizing vessel 14 from the mold 16 and breaking the plastic extending from the nozzle 94 of the plasticizing vessel 14 into the sprue 92 of the mold 16. The plastic in this passageway is sometimes also referred to as the sprue. The clamping members 41 are released from clamping engagement with the mold 16 and the mold may be transported to the cooling station 12 (See FIG. 2) for cooling. A second mold 16 may then be placed into the molding station 10 for the next preheating cycle, while the previous mold 16 is cooling down in cooling station 12.

The cooling station 12 includes a frame 220 which is shown resting on a pedestal or base 221. Cooling station frame 220 comprises a set of tie bars 222 which are fixedly connected to and extend upward from a base plate 225 to an upper plate 226. A cooling station linear actuator 228, including a hydraulic cylinder 229 and a piston 230 with a removable piston head 231 is mounted on the upper plate 226 of the frame 220 with the piston 230 extending downward or inward through a hole in the upper plate 226.

The mold 16 transferred from the molding station 10 is positioned on top of a support flange 232 which is supported on and separated from the mold frame base plate 225 by a rigid insulating layer 233. An upper end of the support flange 232 is smaller in diameter than the mold cavity 69 and engages the mold plunger 71 when the mold 16 is positioned on the upper spacer support flange 232.

Immediately after positioning the mold 16 in the cooling station 12, an extension tube 237 and one or more rigid insulating discs 239 may be positioned on top of the inlet end wall 70 of the mold 16 and aligned with the piston head 231. The piston 230 is then extended until the piston head 231 engages the extension tube 237 which drives the mold 16 downward pressing the mold plunger 71 against the support flange 232 and compressing the molten plastic in the mold cavity 69. The amount of pressure applied depends on the work material and should be high enough to prevent the formation of air voids and pores in the molded part and to prevent delamination of the molded part.

For example, the holding pressure for PEEK during the cooling stage is approximately 2,500 psi and should be maintained until mold temperature gradually drops to the mold opening temperature. Special precautions should be taken to provide an equal cooling rate for all of the mold members as well as the support flange 232 of cooling station similar to base mounting flange 66 of the injection station. The support flange 232 may be provided with an electrical cartridge heater 242 to control the temperature of the support flange 232. The electric heaters of the mold inlet end wall 70 and the band heater 85 of the mold sidewall 68 should also be controlled in such a way to provide uniform cooling at desired cooling rate of the molded part. Programmable logical controllers (PLC) may be efficiently employed for this purpose. When the molded part is solidified and its temperature is brought under the heat deflection temperature, the mold may be opened and the molded part removed from the mold 16.

To remove the molded part from the mold 16, the cooling station piston 230 is first retracted which releases the pressure within the mold cavity 69. The extension tube 237 and insulating discs 239 are removed from between the piston head 231 and the mold inlet end wall 70. Steps are then taken to remove the inlet end wall or upper flange 70 from the rest of the mold 16. The dovetail clamps 109 are removed from the mold 16 and the piston head 231 is replaced with a flange remover, not shown. The mold 16 is clamped to the cooling station frame base plate 225 using clamping assemblies or clamps 245 which are similar in construction to clamping assemblies 40. The flange remover is attached to the mold inlet end wall or upper flange 70 and the piston 230 is retracted to separate the mold inlet end wall 70 from the sleeve 82 which breaks the plastic solidified in the sprue 92.

The clamping assemblies 245 are then disengaged and the mold 16 is engaged by the flange remover and raised. A second extension tube (not shown) is positioned beneath the mold 16 in engagement with the mold plunger 71. The piston 230 with the piston head 231 reattached is then extended to engage the metal sleeve 82 of the mold 16. The piston 230 is further extended to push the remaining portions of the mold 16 off of the molded part which extends upward into the hollow center of the piston head 231.

In successive cycles, the plasticizing vessel 14 generally does not have to be preheated prior to the pouring of the granules for the next shot as the plasticizing vessel 14 is sufficiently hot for compaction of the granules. However, because the mold was cooled to allow the molded part to solidify, all the mold members, including sleeve 82, inlet end wall 70 and mold plunger 71 are preferably reheated to a desired temperature as described above.

Effect of Heating Cores: The heating cores 160 extending into the plasticizing vessel cavity 121 significantly reduce the heating time required for equalization of the temperature throughout the entire volume of the plasticizing vessel cavity 121. When there are no cores in the vessel 14, heat is delivered to the relatively cold central region of compacted pellets only by thermal conduction through the pellets. The degree of compaction has a direct influence on the rate of heat transfer by thermal conduction.

Solid thermoplastic granules themselves have relatively low thermal conductivity due to physical properties of the polymer structure. The compacted polymer granules have an even lower thermal conductivity than the solid polymer due to the presence of thermal resistances on the interfaces between the granules and low thermal conductivity of the air trapped therebetween. The degree of compaction increases with the increase in applied pressures and temperatures of preheated pellets. The preheating temperature of the pellets prior to compaction has an upper limit since overheating of the pellets with excess air will cause undesirable oxidation or discoloration of the pellets, which will cause a reduction in quality of the molded product. Another disadvantage of overheating the pellets is the formation of agglomerates or clusters, which will cause difficulties in handling during transportation and pouring into the plasticizing vessel. For these reasons, the applied compaction pressure should be as high as practical. The degree of compaction is still limited even with high pressures because the air trapped therebetween will expand after removing the applied pressure causing the reduction of the degree of compaction. The existing limits on the degree of compaction of the pellets results in increased heating time required to heat the pellets to the injection temperature in the plasticizing vessel 14. The heating time of the pellets is longer then may be expected for solid polymer piece.

The primary purpose of employing the cores 160 in the plasticizing vessel 14 is to deliver the heat directly to the central region of compacted pellets using the advantage of the metal cores 160 having much higher thermal conductivity compared to that of the polymer pellets. These metal cores 160 may be heated by conduction from the other mold members as discussed previously or separately by electrical cartridge heaters 163 inserted into the cores 160, which will significantly reduce the heating time. The significant reduction of heating time may be obtained due to the following: delivery of additional heat directly to the central region of the compacted work material and the reduction of the distance of the heat flow by thermal conduction.

To estimate the effects of the cores on the improvement of the heating process, the transient heat transfer process in the plasticizing vessel 14 a single core may be compared to a vessel without a core. An analytical solution of the problem may be found, for example, in the book “Conduction of Heat in Solids” by H. S. Carslaw and J. C. Jaeger, New York, Oxford University Press, 1947. However, because the analytical solution is too complex for the scope of this description, the numerical method of Finite Differences for transient heat transfer calculations is used herein. This method is described in detail, for example, in the book “Heat-Transfer Calculations by Finite Differences” by G. M. Dusinberre, Scranton, International Textbook Co., 1961.

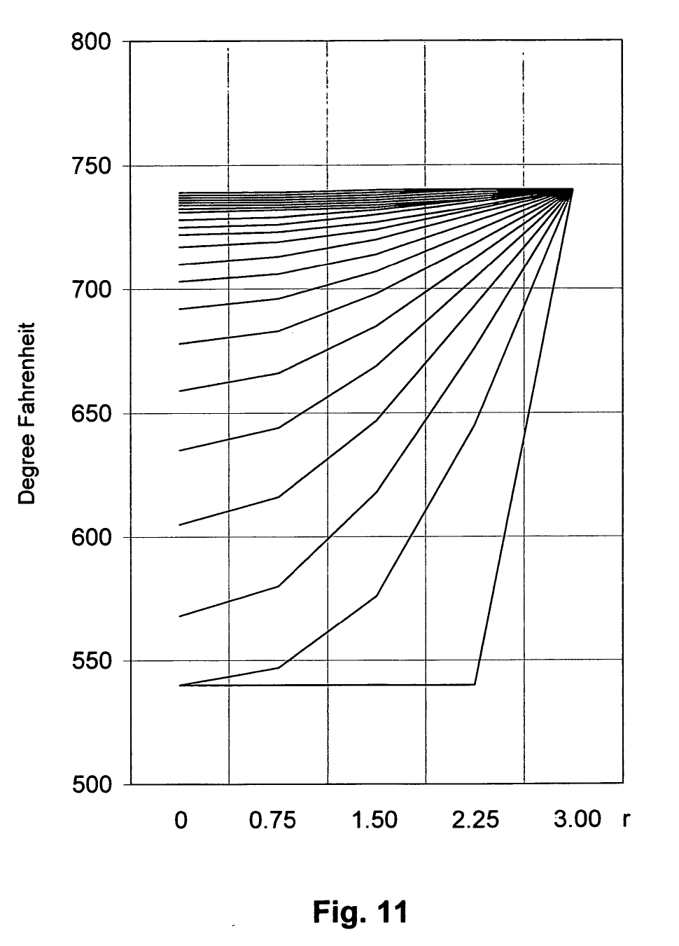

A first sample calculation, is based upon use of pellets of PEEK (polyetheretherketone) which are preheated to the heat deflection temperature 540° F. as described above and compacted in the plasticizing vessel 14 at this temperature. The temperature of the vessel's sleeve 115 is initially at the desired injection temperature, which is 740° F. for PEEK and remains constant during heating time. The inner radius of the sleeve is equal to 3 inches. The edge effects are neglected and heat flow is considered as radial one-dimensional in the direction toward the central axis of the sleeve. Transient heat transfer temperatures were calculated for given initial conditions and are shown in FIG. 11. The temperatures are calculated in 5 points spaced equally in the direction of the flow by intervals Δr=0.75 inches. Left point corresponds to the central axis of the sleeve 1, while right one to its inner surface. Time intervals between series of lines are equal to:

$$Δ {τ}_{1} = \frac{3}{4} \cdot \frac{c ρ}{k} \cdot {( Δ r )}^{2}$$

where:
c—is specific heat of compacted pellets, Btu/lb ° F.;
ρ—is the density of compacted pellets, lb/cu ft;
k—is thermal conductivity of compacted pellets, Btu/hr ft ° F.

As can be seen from FIG. 11, it requires 22 time increments Δτ₁ to equalize the temperature in the entire volume of the vessel 14 without the core with total heating time

$${t}_{1} = 22 \cdot \frac{3}{4} \cdot \frac{c ρ}{k} \cdot {( Δ r )}^{2}$$

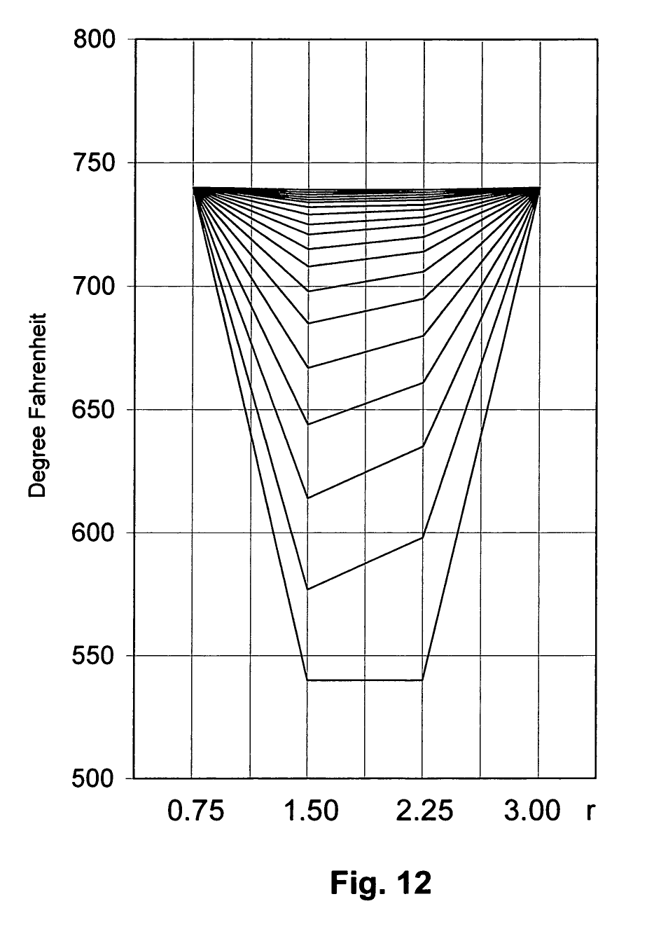

Considering the case with a single core 160 of diameter 1.5 inches inserted into the center of the same vessel 14 containing pellets of PEEK with the same degree of compaction. Initial temperatures of the compacted pellets and the vessel 14 are the same as in the first case and are 540° F. for pellets and 740° F. for the sleeve 115 of the vessel 14. The initial temperature of the core 160 is also equal to 740° F. and remains constant during the heating time. Transient heat transfer temperatures were calculated for given initial conditions and are shown in FIG. 12. The temperatures are calculated in 4 points spaced equally in the direction of the flow by intervals Δr=0.75 inches. Left point corresponds to the surface of the core while the right point corresponds to the inner surface of the vessel 14. Time intervals between series of lines are equal to:

$$Δ {τ}_{2} = \frac{1}{4} \cdot \frac{c ρ}{k} \cdot {( Δ r )}^{2}$$

As can be seen from FIG. 12, it requires 20 time increments Δτ₂ to equalize the temperature in the entire volume of the vessel 14 containing the core 160 with the total heating time

$${t}_{2} = 20 \cdot \frac{1}{4} \cdot \frac{c ρ}{k} \cdot {( Δ r )}^{2}$$

The insertion of one core 160 having a diameter of 1.5 inches reduces the heating time more then 3 times, while the volume capacity of the vessel is reduced by only 6%. If several cores 160 of smaller diameter are inserted, the effect of the reduction of heating time will be even more significant due to reduced distances between hot surfaces and, hence, reduced distances of heat flow.

A displacement-injection molding system utilizing conventional electrical heaters for heating and molding thermoplastics was built similar to the embodiment discussed above and shown in FIG. 1. This molding system was used for molding round parts having a diameter of 4 inches and 6.5 inches in length, from pellets of high performance engineering thermoplastic, PEEK CF 30%. Two variations of the plasticizing vessel 14 were tested in this system.

In the first design, the plasticizing vessel 14 contained a single core having a diameter of 1.5. The core 160 was centrally located relative to the stationary end wall 119 generally in alignment with the nozzle 94. This core contained side holes connected to the nozzle hole to permit the molten plastic to flow from the vessel 14 into the mold cavity 69. The second plasticizing vessel 14 included five cores 160 and was constructed in the manner discussed above and as generally shown in FIG. 4. The volume reduction of the plasticizing vessel cavity 121 due to the five cores was 14% compared to 6.2% for the single core of diameter 1.5 inches. The heating time for the five core design was reduced to thirty minutes which was approximately one sixth of the heating time for a vessel with a single core and one eighteenth the heating time for a vessel without heating cores. Molded parts made by the use of the displacement injection molding system also exhibited improved mechanical properties and dimensional stability in comparison with similarly shaped parts made by compression molding.

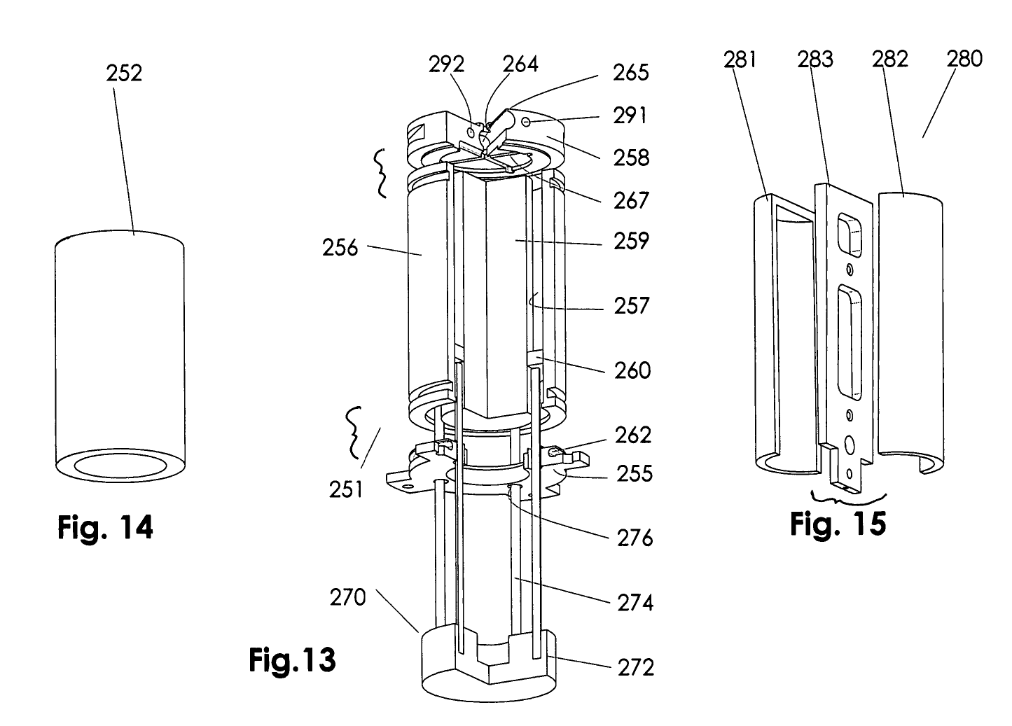

Displacement Mold for Forming Hollow Tubes: Turning to FIGS. 13 and 14 there is shown an alternative embodiment of a mold 251 which may be used to mold relatively thick walled hollow tubes 252 from the work material as generally shown in FIG. 14. The tube forming mold 251 includes a base mounting flange 255, a mold sidewall 256, defining a variable volume mold cavity 257, an inlet end wall or upper flange member 258 a central, cylindrical core 259 and a moveable mold member, wall or plunger 260 slidably mounted between the mold sidewall 256 and the central core 259 to vary the volume of the mold cavity 257. The central core 259 of tube forming mold 251 is removably connected to and extends along a central axis of the mold 251 from the inlet end wall 258 of the mold 251 past the opposite end of the mold sidewall 256 and through a central opening in the base mounting flange 255. The mold plunger 260 is annular and slides over the central, cylindrical core 259. Electric heaters, such as cartridge heaters (not shown) may be used for heating the mold 251. For example, a bendable cartridge heater (not shown) may be mounted within a groove 262 in the mounting flange 255 for heating the flange 255 and adjacent portions of the mold sidewall 256. A band heater (not shown) is preferably secured around the mold sidewall 256 to heat the sidewall 256 similar to the band heater 85 as shown in FIG. 3. In addition, linear cartridge heaters (not shown) may be inserted in bores 291 and 292 formed in the inlet end wall or upper flange 258 of the mold 251 to heat the inlet end wall 258 and the core 259.

The inlet end wall or upper flange 258 of the mold 251 includes a sprue 264 extending centrally therethrough with a valve 265 for selectively opening and closing the sprue 264. Upstream of the valve 265, the sprue 264 comprises a single central passageway and downstream of the valve 265 the sprue branches out into four channels or runners 267 which distribute and deliver molten plastic flowing therethrough to the mold cavity 257 through several (four shown) separate outlets spaced 90 degrees apart and past the central core 259.

A back pressure head or piston extension member 270, adapted to be supported on the end of the piston 261 of the back pressure assembly 20 is used for acting on the annular mold plunger 260. The back pressure head 270 includes a cylindrical base 272 sized to conform to the end of the piston 261 and several cylindrical fingers 274 (four shown) projecting upward therefrom. The back pressure head 270 is positioned on the end of the piston 261 and advanced upward until the fingers 274 extend through aligned finger receiving bores 276 formed in the base mounting flange 255 and into engagement with a lower surface of the annular plunger 260. The finger receiving bores 276 are equally spaced around the hole in the mounting flange 255 for the central core 259. Abutment of the annular plunger 260 against the upper surface of the base mounting flange 255 prevents the plunger 260 from sliding past a lower end of the mold sidewall 256.

After the members forming the mold 251 are preheated, the piston 261 of back pressure assembly 20 is fully extended to advance the annular mold plunger 260 in close proximity to the mold inlet end wall 258. The valve 265 is opened and molten plastic is injected into the mold 251 at a forward pressure which exceeds the back pressure acting on the annular mold plunger 260 so that the molten plastic causes the piston 261 to retract increasing the volume of the mold cavity 257 in proportional relationship to the amount of plastic injected therein. Molten plastic is injected into the mold 251 until the annular plunger 260 engages the base mounting flange 255 at which point the mold cavity 257 has reached its maximum volume.

The contents of the mold 251 are maintained under pressure as the mold is allowed to cool. Once the contents of the mold have cooled a sufficient amount to be removed from the mold 251, the pressure thereon is released and the molded part is removed from the mold 251. The steps of cooling the mold and removing the molded part from the mold 251 may be performed at a cooling station similar to cooling station 12 discussed previously.

To hold the contents of the mold 251 under pressure at the cooling station 12, the back pressure head 270 may be positioned between the mold 251 and the frame base plate 225, with the fingers 274 of the head 270 engaging the annular mold plunger 260. The piston head 231 is then advanced into engagement with the inlet end wall or upper flange 258 of the mold 251 to press downward on the mold 251, compressing the annular mold plunger 260 against the back pressure head fingers 274.

After the molded part has cooled to a sufficient degree to permit removal, the piston 230 is retracted, and the mold 251 is clamped to the base plate 225. A flange remover is then connected to the piston 230 and to the upper flange or inlet end wall 258 of the mold 251. The piston 230 is then retracted to separate the upper flange 258 from the mold sidewall and break the hardened plastic sprues formed in the sprue channels 267. The piston head 231 is then reattached to the piston 230 and the mold is positioned on the back pressure head 270. The piston 230 is then extended to push the mold sidewall 256 off of the molded part. The core 259 may remain positioned within the hollow tube but may be removed using tools adapted for use with the piston 230 of the cooling station.

It is also foreseen that the core could be a collapsible core 280 such as the collapsible core shown in FIG. 15. The core 280 includes outer core portions 281 and 282 and a central core member or portion 284 which may be assembled together to form a generally cylindrical core. After separation of the molded part and core 280 from the remaining portions of the mold 251, one or more tools, including the piston 230, can be used to force the central core portion 284 out from between the outer core portions 281 and 282. The outer core portions 281 and 282 then collapse and are readily removable from the hollow portion of the molded tube.

It is to be understood that while certain forms of the present invention have been illustrated and described herein, it is not to be limited to the specific forms, process steps or arrangement of parts described and shown and that the invention should be limited only by the claims. It is to be understood for example that the injection system could be utilized without a cooling station and the mold can cool down in the injection station. Such a simplified system nevertheless will have a prolonged process time.

It is also foreseen that the heating cores such as cores 160 can take a wide variety of shapes and geometries. Similarly, the cross-section of the circumferential sidewall 68 of the mold 16 and sidewall 125 of plasticizing vessel 14 may take a wide variety of shapes including rectangular, triangular or ovate or other more complicated geometries. The term circumferential is not intended to be limited to circular shapes but intended to include other geometries as indicated above. Although the molding process of the present invention is particularly well adapted for molding parts of stock shapes and uniform cross-section, it is to be understood that the process could be utilized to mold parts of more complicated shapes. To mold parts of more complex shapes, multiple mold plungers could be utilized which would then stop at different positions within the mold cavity.

Although the mold sidewall 68 and inlet end wall 70 are described as being stationary with the mold plunger 71 moving relative to the sidewall 68 and end wall 70, it is foreseen that plunger 71 could be maintained stationery with the sidewall 68 and the end wall 70 moving relative to the plunger 71 to vary the volume of the mold cavity. In addition, it is foreseen that the plasticizing vessel utilizing core heating elements could be used without the variable volume mold and back pressure assembly, such as conventional injection molds. Similarly, the variable volume mold utilizing back pressure to avoid the formation of voids or pores could be used with different plasticizing vessels. Although the ejection mechanism shown and described herein is a plunger type mechanism it is to be understood that the term ejection mechanism is not intended to be limited to plunger type mechanisms and may include mechanisms such as screws or other functionally equivalent mechanisms, particularly when the variable volume mold assembly utilizing back pressure as disclosed in FIG. 3 is used with a plasticizing vessel other than that of the type disclosed in FIG. 4.

It is also to be understood that although the end walls of the plasticizing vessel 14 and the mold 16 are generally shown as planar, the end walls could be of a variety of configurations including conical, hemi-spherical or other geometries that generally extend across and close the circumferential sidewall.

What is claimed is:

1. A process for molding a part comprising the steps of:
a) providing a plasticizing vessel;
b) filling at least a portion of said plasticizing vessel with granules of a selected polymer;
c) heating said granules in said plasticizing vessel to an injection temperature of the selected polymer;
d) displacing said selected polymer heated to said injection temperature out of said plasticizing vessel and into a mold cavity of a mold while simultaneously expanding the volume of the mold cavity in direct proportion to the amount of the selected polymer displaced into the mold cavity.

2. The molding process as in claim 1 further comprising applying a forwardly directed pressure to displace said selected polymer out of said plasticizing vessel and applying a back pressure to resist expansion of the volume of the mold cavity wherein said forward pressure exceeds said back pressure by an amount sufficient to cause the volume of the mold cavity to expand.

3. The molding process as in claim 1 wherein between the filling and heating steps the process further comprises the step of compacting the granules in said plasticizing vessel.

4. A part molded in accordance with the process of claim 1.

5. A plasticizing vessel for heating granules of a polymer work material to an injection temperature; said plasticizing vessel including a circumferential sidewall defining an outer periphery of a plasticizing vessel cavity adapted to receive granules of the polymer work material; said plasticizing vessel further including an outlet end having an outlet formed therein in communication with said plasticizing vessel cavity and a plunger slidably mounted in said plasticizing vessel cavity and moveable toward and away from said outlet end of said plasticizing vessel; at least one heat transfer member extending into said plasticizing vessel cavity in parallel relationship to an axis of said plasticizing vessel cavity; said plunger having at least one opening extending therethrough corresponding to and receiving said at least one heat transfer member such that said plunger is advanceable across said heat transfer member as said plunger is advanced toward said outlet end of said plasticizing vessel; a heating element connected to said plasticizing vessel for generating heat to be distributed through said at least one heat transfer member to granules of the polymeric work material positioned in said plasticizing vessel cavity to heat the granules to the injection temperature of the polymeric work material; said plunger selectively advanceable toward said outlet end of said plasticizing vessel for ejecting polymeric work material heated to its injection temperature out of said plasticizing vessel cavity through said outlet.

6. The plasticizing vessel as in claim 5 wherein said heating element comprises at least one cartridge heater inserted in said at least one heat transfer member.

7. A molding system including the plasticizing vessel as set forth in claim 5 and a mold having a mold cavity for receiving polymeric work material ejected from said plasticizing vessel.

8. A plasticizing vessel for heating granules of a polymer work material to an injection temperature comprises: a circumferential sidewall generally defining a cavity adapted to receive granules of the polymer work material; an outlet end wall extending across one end of said circumferential sidewall; and a plunger removably and slidably mounted within said circumferential sidewall; said outlet end wall having an outlet formed therein; said plasticizing vessel further including a plurality of heat transfer members extending into said cavity in parallel alignment with an axis of said cavity, each heat transfer member having a heating element connected thereto; said plunger having a plurality of openings extending therethrough sized to receive a respective one of said heat transfer members and to permit said plunger to slide thereacross; said plunger selectively advanceable toward said outlet end wall of said plasticizing vessel for ejecting polymeric work material out of said plasticizing vessel cavity through said outlet.

9. A molding system including a plasticizing vessel for heating a polymer work material to its injection temperature and a mold into which said polymer work material is injected to from a molded part; said plasticizing vessel having an ejection mechanism for ejecting the polymer work material heated to its injection temperature out of said plasticizing vessel under a first pressure and into said mold; said mold having a stationary mold member and a moveable mold member cooperatively forming a mold cavity; said moveable mold member moveable relative to said stationary mold member to vary the volume of said mold cavity from a minimum volume to a maximum volume, wherein the molded part is formed in said maximum volume of said mold cavity.

10. A molding system including a plasticizing vessel for heating a polymer work material to its injection temperature and a mold into which said polymer work material is injected to from a molded part; said plasticizing vessel having an ejection mechanism for ejecting the polymer work material heated to its injection temperature out of said plasticizing vessel under a first pressure and into said mold; said mold including a circumferential sidewall, an inlet end wall connected to said circumferential sidewall and closing a first end thereof and having a sprue extending therethrough and a mold plunger slidably mounted within said circumferential sidewall; said mold plunger advanceable between a first position in close proximity to said inlet end wall and a second position proximate a second end of said circumferential sidewall such that a mold cavity sized to form a molded part is formed between said inlet end wall and said plunger; said molding system further comprising a back pressure actuator engaging said plunger and urging said plunger toward said inlet end wall under a second pressure which is smaller than said first pressure but sufficient to permit displacement of said polymer work material from said plasticizing vessel into said mold cavity under pressure.
